(19) United States
(12) Patent Application Publication
(10) Pub. No.: US 2014/0315325 A1
(43) Pub. Date: Oct. 23, 2014

(54) ASSEMBLY COMPRISING A REACTION VESSEL AND A SAMPLE MATRIX, SAMPLE MATRIX COMPRISING AN UPPER ADSORBENT LAYER AND A LOWER LATERAL FLOW LAYER

(71) Applicant: Epistem Limited, Manchester (GB)

(72) Inventor: Ben Cobb, Wiltshire (GB)

(73) Assignee: Epistem Limited, Manchester (GB)

(21) Appl. No.: 14/358,563

(22) PCT Filed: Nov. 16, 2012
(86) PCT No.: PCT/GB2012/052847

§ 371 Date: May 15, 2014

(30) Foreign Application Priority Data
Nov. 16, 2011 (GB) 1119763.9
Mar. 16, 2012 (GB) 1204665.2

(51) Int. Cl. G01N 1/28

(52) U.S. Cl. CPC G01N 1/28
USPC 436/174; 422/547

(57) ABSTRACT

An assembly and related methods are described for the preparation and processing of samples in molecular biology assays and nucleic acid amplification reactions. The assembly allows rapid and easy processing with reduced sample handling compared to known sample preparation apparatus and methods. The assembly comprises a reaction vessel, a sample matrix and a lid. The invention further provides an integrated punch to punch out discs of the sample matrix into the reaction vessel (without handling); thereby reducing the sample handling required to generate the final amplified nucleic acid product.

### FIELD OF THE INVENTION

The present invention relates to an apparatus for sample preparation and processing in molecular biology assays and reactions, for example, nucleic acid amplification reactions including polymerase chain reaction (PCR) and the like.

### BACKGROUND TO THE INVENTION

PCR is a convenient method for amplifying particular target nucleic acid sequences in a biological sample. It is often used for forensics or diagnostics purposes, in order to detect markers which may be used for example to identify an individual to whom a DNA sample belongs; or to determine whether a particular pathogen is present in a sample. For such purposes, it is useful to have a relatively rapid assay, which may mean that extensive sample preparation and clean up cannot be undertaken.

Most clinical samples require some processing to make the sample compatible with PCR. It is known to use paper-type filters to remove inhibitors and to provide clean sample for the PCR reaction. However, conventionally, such filters still require some user handling and intervention in order to transfer the sample from the filter to the PCR reaction, and to carry out the reaction itself. It is among the objects of the present invention to provide an alternative means for sample preparation for samples for biological analysis; in preferred embodiments, this is integrated with a reaction vessel for conducting said analysis, to provide rapid and easy processing for the user.

### SUMMARY OF THE INVENTION

According to a first aspect of the present invention there is provided an assembly comprising:

a reaction vessel for receiving a sample for analysis, the reaction vessel defining a body and an opening;

a sample matrix adjacent the opening, for adsorbing a sample applied to the matrix;

a lid for closing the reaction vessel opening and covering the sample matrix, the lid including a punch member designed to punch out a portion of the sample matrix and to detach said portion from the remainder of the sample matrix, such that said portion is able to enter the body of the reaction vessel.

The present invention therefore includes a sample matrix which may be used to process or otherwise prepare a sample applied to it. The punch member can then be used to punch out a portion of the matrix carrying the prepared sample, allowing it to drop into the body of the reaction vessel. Suitable reagents (for example, PCR reagents) may then be added to the reaction vessel, and a desired assay undertaken.

In preferred embodiments, the apparatus comprises multiple reaction vessels and punch members. The punch members may be included in a single common lid, or there may be multiple separate lids.

The punch member may comprise a sprung rod. The rod may be cylindrical, preferably a hollow cylindrical rod. The punch member may comprise a sharpened cutting edge. In certain embodiments this may be for example V shaped or otherwise pointed, but preferably the cutting edge is generally circular.

The member may comprise a sprung rod and a separate cutting blade; for example, the sprung rod may extend through the centre of a generally cylindrical cutting blade, with the spring rod being arranged to urge the cutting blade forwards to cut through the sample matrix. This arrangement has the advantage that the sprung rod may be arranged to extend further when actuated in order to help urge the cut portion of the sample matrix away from the remainder of the matrix and into the reaction vessel. In certain embodiments, the sprung rod may be arranged to retain the cut portion of the sample member, at least temporarily, and to extend into the lower portion of the body of the reaction vessel when actuated. In use, this can ensure that the cut portion of the sample matrix is pushed into any reagents present in the reaction vessel.

The rod and cutting blade are preferably disposed in a supporting structure. The lid may comprise this supporting structure.

Preferably the lid comprises an actuating member, for example a button, arranged to urge the punch member into contact with the sample matrix when actuated by a user.

The apparatus may further comprise a removable cover covering the sample matrix. for example the cover may be a removable foil or wrap or the like. The cover may be arranged to cover only the sample matrix, or the whole assembly, or the matrix and lid, or the matrix and reaction vessel. In use the cover is intended to protect the sample matrix (and/or the reaction vessel) from contamination prior to use. When ready, the user removes the cover, and applies the sample to the sample matrix.

The sample matrix may be disposed in a carrier member; for example, a carrier member which is received into the opening of the reaction vessel. The carrier member may extend into the body of the reaction vessel, and serve to close the opening. This helps to ensure the sample matrix is held securely, and prevents contamination of the interior of the reaction vessel. The sample matrix may be attached to the carrier member, for example by ultrasonic welding, heat staking, adhesive, and so on. The carrier member is preferably of plastics or elastomeric material. In preferred embodiments the carrier member includes a thinner portion in contact with the sample matrix adjacent the punch member; this provides a solid surface against which the punch member may push when punching the matrix, to improve cutting reliability. The use of a thinner portion means that the punch member may punch through the carrier member as well as the sample matrix, to allow the matrix to enter the body of the reaction vessel. In certain embodiments, the thinner portion of the carrier member may be self-sealing; for example, the member may be formed of an elastomeric material to reseal the reaction vessel after the punch member has been actuated.

The sample matrix may comprise a colour change reagent, to indicate when and/or where sample has been applied to the matrix. For example, the reagent may change colour when wet, and/or after drying. The sample matrix may include indicia to mark where sample is to be applied; for example, printed markings.

In certain embodiments, the sample matrix may further comprise one or more reagents for conducting a desired reaction; for example, the matrix may comprise lyophilised PCR reagents, and/or lyophilised enzymes. These reagents will then be reconstituted when the sample matrix is contacted with liquid in the reaction vessel. In this way the reagents may be kept separate from one another until ready to be activated to carry out a reaction. The matrix may comprise multiple reagents; these may be combined within the matrix, or may be kept separate, for example being incorporated into separate layers of a composite matrix. The reagents may be incorporated into an additional layer of a composite matrix.

The apparatus may further comprise a capsule arranged to be pierced by the punch member upon actuation. The capsule may contain reagents, for example, buffer solution, reaction solution, or the like, or may contain water, to be released on piercing. In this way, the contents of the capsule may be arranged to be released together with the punched portion of the sample matrix, and both may enter the body of the reaction vessel together.

The reaction vessel may further contain lyophilised reagents.

In certain embodiments, the reaction vessel may contain gelified reagents. For example, reagents may be incorporated into an agarose or other gel; the gel may be selected to as to melt below the temperatures used in the assay to be performed. The use of gelified reagents removes the need for separate pipetting of reagents and integrates the complete sample preparation, extraction, and PCR process. In use, for example, the gelified reagent may be melted prior to sample preparation such that the punched portion of the sample matrix can contact the liquid or semi-liquid reagent.

The specific reagents to be used will of course depend on the nature of the reaction to be carried out; the skilled person will be aware of suitable reagents which may be included, either in solution (for example in a capsule), or in gelified or lyophilised form.

The sample matrix is preferably a composite matrix; more preferably a composite paper matrix. The sample matrix may be a paper matrix. In preferred embodiments, the sample matrix is a composite matrix, and includes an adsorbent upper layer, and a lateral flow layer. The matrix may also include a semipermeable layer disposed between the upper layer and the lateral flow layer.

The absorbent upper layer has a number of optimal characteristics. The material must be hydrophilic and must not bind irreversibly nucleic acids, alternatives such as Whatman FTA paper bind nucleic acids and require heat treatment of 15-30 minutes to remove bound nucleic acids. The absorbent material must not release PCR inhibitors and/or release substances or chelating reagents used for the whitening process that may interfere with PCR. The absorbent material is preferably made of cellulose (although porous polymers such as polyesters may also be equally effective). Important characteristics are Liquid Filtration Speed and Density, Basis Weight and Water Absorbency. For example, preferred materials include Shleicher & Schuell Inc. 903. Alternatives are; Schelicher & Schuell “GB002”, “GB003” and “GB004”, Fairfield N.J. “BFC1” and Whatmann “3MM” (although this last one would require impregnation with a surfactant mixture).

Preferred values for the important characteristics include:

| Liquid filtration speed | Densometer | Retained precipitates |
|---|---|---|
| TAPPI T471 | TAPPI T471 | ASTM D981-56 |
| u.m. 572 | u.m. 572 | (8 to 30 um particles) |
| ASTM E832-9.3 | ASTM 726 | |
| (7.3 seconds) | (20 seconds) | |
| Surface | Basis weight | Caliper |
| Smooth, not hardened | TAPPI T471 | TAPPI T471 |
| | u.m. 572 | u.m. 572 |
| | TAPPI T410 | TAPPI T411 |
| | ASTM 646 | ASTM 643 |
| | (179 g/m2) | (0.52 mm thick) |
| Water absorbency | Klemm | Wet strength—5 sheets |
| TAPPI T441 | TAPPI T441 | TAPPI T471 |
| ASTM 3285 | ASTM 3285 | ASTM 774 |
| (4.5 g/100 cc) | (34/16 deg/min) | (7.0 psi) |

The preferred upper layer may have any or all of these values, alone or in any combination.

The lateral flow layer may be nitrocellulose.

The adsorbent layer is preferably 0.5-1 mm in thickness; the lateral flow layer may be 0.1-0.2 mm in thickness.

The sample matrix may further comprise a support layer; for example, a plastics support, such as polyester, disposed adjacent the lateral flow layer. This may be of the same or similar order of thickness as the lateral flow layer; for example, around 0.1 mm.

The paper properties allow the paper to rapidly wick the liquid into the paper, leaving target organisms on the surface, and dehydrate the cellular material on the surface weakening the cell walls and making them lysable by heat. The paper also locks/removes inhibitors in the paper matrix.

A further aspect of the invention provides an assembly comprising:
a sample matrix, for adsorbing a sample applied to the matrix;
a lid covering the sample matrix and for closing a reaction vessel opening, the lid including a punch member designed to punch out a portion of the sample matrix and to detach said portion from the remainder of the sample matrix, such that said portion is able to enter the body of said reaction vessel.

A still further aspect of the invention provides a sample processing assembly, the assembly comprising:
a sample matrix, for adsorbing a sample applied to the matrix; and
a punch member designed to punch out a portion of the sample matrix and to detach said portion from the remainder of the sample matrix;
wherein the sample matrix is a composite matrix, and includes an adsorbent upper layer, and a lateral flow layer.

The upper layer may be cellulose; and/or the lateral flow layer nitrocellulose.

A further aspect of the invention provides a method for preparing a sample for analysis, the method comprising:
providing a reaction vessel having a sample matrix located adjacent the opening of the vessel, and containing reagent for sample analysis in the vessel;
adsorbing a sample onto the sample matrix;
punching out a portion of the sample matrix, and allowing the sample matrix to enter the reaction vessel to thereby contact the reagent and the sample.

In a preferred embodiment, the reagent is a gelified reagent. This allows the sample to be prepared without the need to add further reagents, or for example to measure and pipette additional liquid components for the reaction. In a most preferred embodiment, then, the sample is ready for analysis without addition of further reagents. The gelified reagent is preferably arranged so as to have a melting point at or below the temperature at which the intended reaction is to take place.

In an alternative embodiment, the reagent may be lyophilised; the method may then comprise the further step of adding liquid reagents to the reaction vessel, although this is not preferred. In some embodiments, the method may comprise the step of piercing a capsule containing liquid reagent in order to release the liquid reagent into the reaction vessel; this avoids the need for pipetting of additional reagents.

In certain embodiments, the sample matrix may further comprise one or more reagents for conducting a desired reaction; for example, the matrix may comprise lyophilised PCR reagents, and/or lyophilised enzymes. These reagents will then be reconstituted when the sample matrix is contacted with liquid in the reaction vessel. In this way the reagents may be kept separate from one another until ready to be activated to carry out a reaction. The matrix may comprise multiple reagents; these may be combined within the matrix, or may be kept separate, for example being incorporated into separate layers of a composite matrix. The reagents may be incorporated into an additional layer of a composite matrix.

A yet further aspect of the invention provides a sample matrix for sample preparation, the matrix comprising an adsorbent upper layer, and a lateral flow layer. The adsorbent layer is preferably made of cellulose. The lateral flow layer is preferably made of nitrocellulose. The adsorbent layer serves to concentrate a sample, while the lateral flow layer rapidly wicks liquid away from the sample to provide an improved drying time. It is therefore possible to rapidly prepare a sample without the need to apply heat, for example. The rapid drying also allows disruption of cellular content, making cellular material more likely to lyse during subsequent sample analysis steps (for example, PCR).

The layers of the sample matrix may be bonded by adhesive. Suitable adhesives will be known to the skilled person.

The invention also provides a method for sample preparation, the method comprising applying a biological sample to a sample matrix, the matrix comprising an adsorbent upper layer and a lateral flow layer, such that the lateral flow layer wicks liquid away from the sample, and solid material from the sample is adsorbed into the upper layer. This allows rapid drying (and in some embodiments, concentration) of the sample without the application of heat.

### BRIEF DESCRIPTION OF THE DRAWINGS

These and other aspects of the invention will now be described, by way of example only, with reference to the accompanying drawings, in which:

FIG. 1 shows a perspective view of an apparatus in accordance with an embodiment of the present invention;

FIG. 2 shows a partially exploded view of the device of FIG. 1;

FIG. 3 shows a further exploded view of the device of FIG. 1;

FIG. 4 shows a fully exploded view of the device of FIG. 1;

FIG. 5 shows a section of the upper portion of the device of FIG. 1 in use; and

FIG. 6 shows a schematic of the sample matrix of the device of FIG. 1.

### DETAILED DESCRIPTION OF THE DRAWINGS

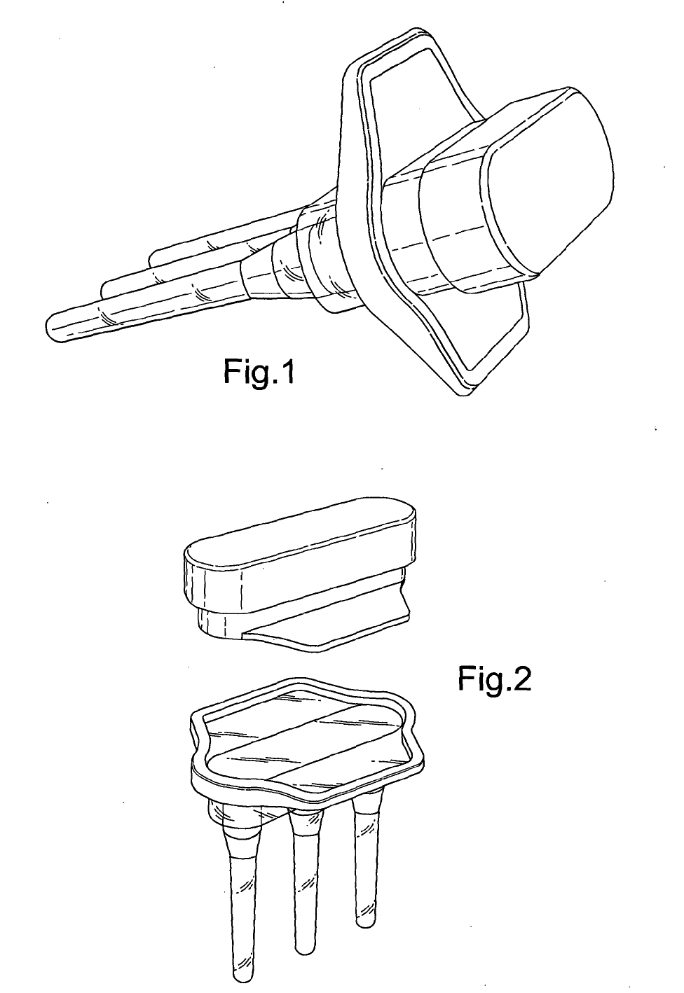

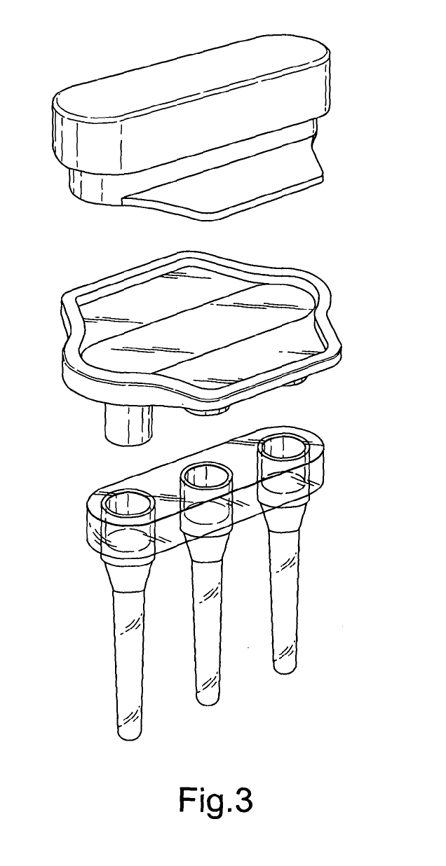

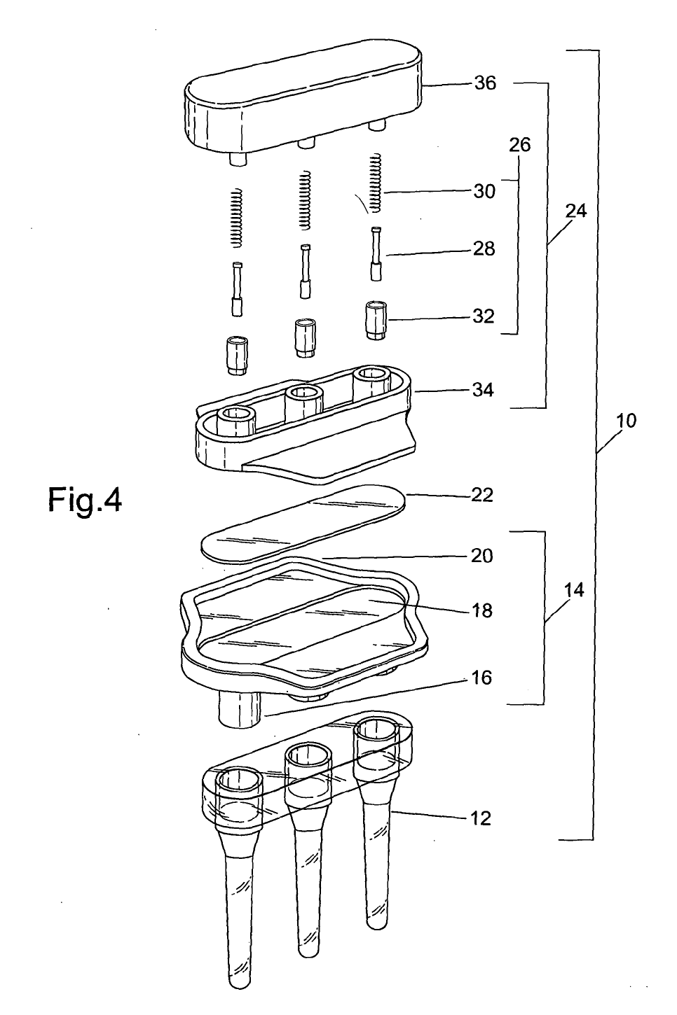

Referring generally to FIGS. 1 to 4, an assembly 10 for use in preparing samples for PCR includes three reaction vessels 12, each of which may contain lyophilised reagents for carrying out a PCR assay. The reaction vessels 12 are moulded as a single piece; in other embodiments the number of reaction vessels may of course vary. The reaction vessels 12 each have a mouth, which mouths are closed by a bung 14 which has portions 16 which extend into the mouths of the reaction vessels. The extending portions 16 are generally cylindrical, being open at the lower part to communicate with the interior of the reaction vessel 12. The upper part of the extending portions 16 is closed by a thin-walled portion 18 of the bung 14, which forms a recess.

The bung 14 in this embodiment is formed with side-extending portions 20 which serve as handles for the user.

The recess formed by the thin-walled portion 18 of the bung 14 receives a sample matrix 22 formed of composite paper. The sample matrix 22 is shown in more detail schematically in FIG. 6, and includes a first layer of cellulose fibres, and a second layer of nitrocellulose fibres. It may also include a support layer. The sample matrix 22 is secured to the bung 14 by ultrasonic welding.

The reaction vessel 12 and bung 14 are held together by means of retaining clips located on the underside of the thin walled portion 18 that run along the length of the side-extending portions 20. The retaining clips are positioned so as to lock into place against the reaction vessel 12. Clipping the reaction vessel 12 and bung 14 together ensures that during use the two cannot become separated resulting in the cross contamination of neighbouring wells of the reaction vessel 12. The reaction vessel 12 and bung 14 may be separated by inserting a tool down each side of retaining clip to release them. Alternatives to clips may be used; for example retaining members, locking means, or other interference structures. In a variant embodiment, the clips or retaining members may be located on the reaction vessel.

Preferably the reaction vessel 12 is made from a polycarbonate for example Makrolon®.

The tubes of the reaction vessel 12 are constructed so when clipped together with the bung 14, the container is pressurised such that any liquid in the tubes of the reaction vessel 12 is held in place.

The sample matrix 22 and bung 14 may before use be enclosed in a removable foil or wrapping (not shown), to protect against contamination.

The assembly 10 also includes a lid 24 which includes a punch member 26 including a plunger 28, a spring 30, and a cutting portion 32. The punch member 26 extends through a support 34 to allow contact with the sample matrix 22. The lid 24 also includes an actuating member 36.

To use the assembly 10, the removable foil is removed from the sample matrix 22 and bung 14, to expose the sample matrix. In some embodiments, sterile water is then added to the reaction vessels in order to dissolve the lyophilised reagents. The reaction vessels are then reclosed with the bung 14.

A sample (for example, sputum) to be assayed is spotted onto the sample matrix 22. The matrix 22 may be marked with indicia to show where the sample should be spotted, and/or may incorporate a reagent which changes colour when a sample has been applied; for example, the reagent may change colour when wet. The composite paper sample matrix is used to prepare the sample for PCR. The first cellulose layer acts as an absorbent layer, and captures cellular content, and provides vertical and horizontal fluid flow. The second nitrocellulose layer provides rapid removal of water via lateral flow, and improves drying speed of a sample applied to the matrix. This operation allows a sample to be dried and prepared for further assay within a few minutes. The matrix may also be impregnated with reagents to lyse cells and release nucleic acids, if desired. Alternatively, or in addition, the matrix may include one or more reagents for conducting a desired reaction, for example, the matrix may include lyophilised enzymes and nucleotides for use in a PCR reaction.

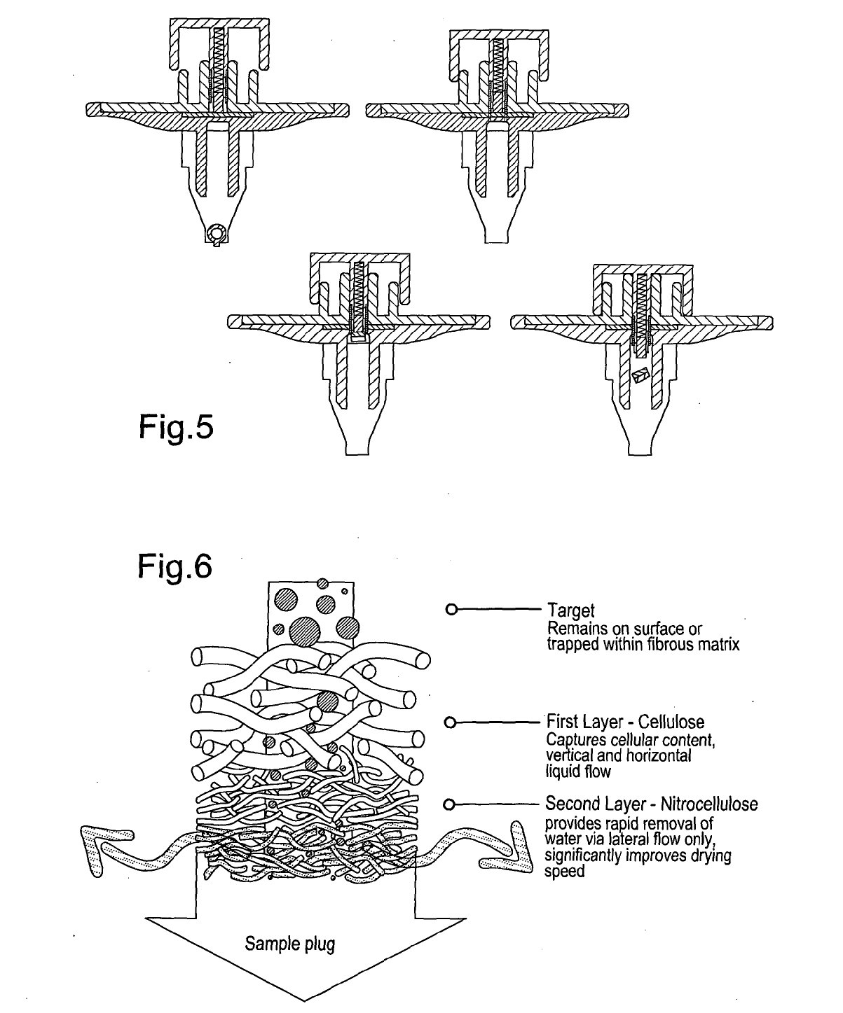

The lid 24 is then placed over the sample matrix 22. The actuating member 36 is depressed, which compresses springs 30 and urges plunger 28 together with cutting member 32 downward through the carrier 34 and into contact with the sample matrix 22. Continued pressure pushes the cutting member 32 through the sample matrix and underlying thin-walled section 18 of the bung 14 to cut a disc of material from the sample matrix and to allow access to the interior of the reaction vessel. The plunger 28 then pushes the cut disc out of the remainder of the matrix and allows it to fall into the reaction vessel. This process is shown in more detail in FIG. 5. The sample matrix is thus loaded with a sample and reagents ready for assay; for example, for PCR analysis. Alternatively, in some embodiments the plunger 28 is adapted to retain the cut disc and continue to push it into the reaction vessel so that it contacts the reagents (for example, liquid reagents) in the body of the reaction vessel.

This operation allows a sample to be readily processed and loaded into a reaction vessel, together with the necessary reagents, in a rapid and simple operation. In modifications of the described embodiment, the plunger and cutting member may be arranged to pierce a capsule containing liquid reagents to release these into the reaction vessel together with the sample matrix. This may avoid the use of lyophilised reagents; or may be used in combination with such reagents. Alternatively, the reaction vessel may contain gelified reagents. Other modifications will be apparent to the skilled person.

1. An assembly comprising:
a reaction vessel for receiving a sample for analysis, the reaction vessel defining a body and an opening;
a sample matrix adjacent the opening, for adsorbing a sample applied to the matrix;
a lid for closing the reaction vessel opening and covering the sample matrix, the lid including a punch member designed to punch out a portion of the sample matrix and to detach said portion from the remainder of the sample matrix, such that said portion is able to enter the body of the reaction vessel.

2. (canceled)

3. (canceled)

4. The assembly of claim 1 wherein the punch member comprises a sprung rod.

5. The assembly of claim 4 wherein the rod is a hollow cylindrical rod.

6. The assembly of claim 1 wherein the punch member comprises a sharpened cutting edge.

7. (canceled)

8. The assembly of claim 1 wherein the lid comprises an actuating member arranged to urge the punch member into contact with the sample matrix when actuated by a user.

9. (canceled)

10. The assembly of claim 1 wherein the sample matrix is disposed in a carrier member.

11. The assembly of claim 10 wherein the carrier member extends into the body of the reaction vessel, and serves to close the opening.

12. (canceled)

13. (canceled)

14. The assembly of claim 1 wherein the lid and the reaction vessel are held together during use by retaining clips, retaining members, locking means, or other interference structures.

15. The assembly of claim 1 wherein the sample matrix comprises a colour change reagent, to indicate when and/or where sample has been applied to the matrix.

16. The assembly of claim 1 further comprising a capsule arranged to be pierced by the punch member upon actuation.

17. The assembly of claim 1 wherein the reaction vessel contains lyophilised reagents.

18. The assembly of claim 1 wherein the reaction vessel contains gelified reagents.

19. The assembly of claim 1 wherein the sample matrix is a composite matrix.

20. The assembly of claim 19 wherein the sample matrix includes an adsorbent upper layer, and a lateral flow layer.

21. The assembly of claim 20 wherein the matrix further comprises a semipermeable layer disposed between the upper layer and the lateral flow layer.

22. (canceled)

23. (canceled)

24. (canceled)

25. (canceled)

26. (canceled)

27. A method for preparing a sample for analysis, the method comprising:
providing a reaction vessel having a sample matrix located adjacent the opening of the vessel, and containing reagent for sample analysis in the vessel;
adsorbing a sample onto the sample matrix;
punching out a portion of the sample matrix, and allowing the sample matrix to enter the reaction vessel to thereby contact the reagent and the sample.

28. The method of claim 27, wherein the reagent is a gelified reagent.

29. The method of claim 27 wherein the sample is prepared without addition of further reagents.

30. The method of claim 27 further comprising the step of piercing a capsule containing liquid reagent in order to release the liquid reagent into the reaction vessel.

31. (canceled)

32. (canceled)

33. (canceled)

34. (canceled)

35. The assembly of claim 1, wherein the sample matrix comprises one or more lyophilised reagents.
